(19) United States
(12) Patent Application Publication
(10) Pub. No.: US 2013/0326937 A1
(43) Pub. Date: Dec. 12, 2013

(54) Method and Apparatus for Increasing Concentration of Stable Water Clusters, and Products Produced Thereby

(71) Applicant: D & Y LABORATORIES, Holden, MO (US)

(72) Inventors: Shui Yin Lo, Pasadena, CA (US); David L. Gann, Holden, MO (US)

(73) Assignee: D & Y Laboratories, Holden, MO (US)

(21) Appl. No.: 13/767,365

(22) Filed: Feb. 14, 2013

Related U.S. Application Data
(60) Provisional application No. 61/657,432, filed on Jun. 8, 2012.

(51) Int. Cl. C01B 5/00

(52) U.S. Cl. CPC C01B 5/00
USPC 44/457; 423/580.1; 422/243; 422/128

(57) ABSTRACT

For increasing the concentration of stable water clusters in water solution an external electric field is applied to provide an alignment of electric dipole moments of the stable water clusters and for growing of the latter, the water solution with the stable water clusters is subjected to vigorous shaking by ultrasound to break the stable water clusters into a greater number of smaller stable water clusters, and products are produced with increased concentration of the stable water clusters.

### CROSS REFERENCE TO A RELATED APPLICATION

This patent application contains a subject matter which is disclosed in provisional patent application Ser. No. 61/657,432 filed on Jun. 8, 2012, and this patent application claims its priority from the above identified provisional patent application under 35 USC 119(a)-(e).

This patent application also claims its priority from non-provisional patent application Ser. No. 12/592,877 filed on Dec. 3, 2009, whose corresponding subject matter is incorporated here by reference thereto and which provides the basis for the claim to priority under 35 USC 119(a)-(e).

### BACKGROUND OF THE INVENTION

The present invention relates to a method and apparatus for increasing concentration of stable water clusters, and to products produced thereby.

Methods and apparatuses for producing stable water clusters and the products which contain the stable water clusters are disclosed in our U.S. Pat. Nos. 8,193,251 and 8,383,688. The methods and apparatuses disclosed in these patents provide efficient production of the stable water clusters. The products with the stable water clusters provide numerous noticeable physical, chemical, biological and medical effects. It is believed that it is advantageous to increase the concentration of the stable water clusters in order to enhance such effects.

### SUMMARY OF THE INVENTION

Accordingly it is an object of the present invention to provide a new method and apparatus for increasing the concentration of the stable water clusters.

In keeping with these objects and with others which will become apparent hereinafter, one feature of the present invention resides, briefly stated, in a method and apparatus for increasing the concentration of the stable water clusters in a water solution, in which the step and means are provided for applying to the water solution which contains the stable water clusters an external electric field providing an alignment of electric dipole moments of the stable water clusters and growing of the stable water clusters.

In accordance with another feature of the present invention, the water solution with the stable water clusters is accommodated in a container, and the applying means are acting means which act on the water solution which contains the stable water clusters in the container and generate the external electric field.

The acting means of the inventive method and apparatus can include two plates spaced from one another and arranged outside of the container which contains the water solution with the stable water clusters so that the container is located between the plates.

The acting means of the method and apparatus of the present invention can include wire means selected from the group consisting of a single wire and a plurality of wires and located in an interior of the container which accommodates the water solution containing the stable water clusters.

In accordance with the inventive method and apparatus, the step and means are further provided, for shaking the water solution which contains the stable water clusters, so as to break the stable water clusters into a greater number of smaller stable water clusters, which subsequently grow larger so that the concentration of the stable water clusters in the water solution is increased.

In the inventive method and apparatus, the means shaking of the water solution which contains the stable water clusters can include means generating ultrasound vibration which provides the shaking.

With the container provided in the inventive method and apparatus and accommodating the water solution with the stable water clusters, the shaking step and shaking means can provide shaking of the container which accommodates the water solution with the stable water clusters.

In accordance with a further feature of the invention, in the inventive method and apparatus with the use of a container accommodating the water solution with the stable water clusters, the shaking step and means include the step and means generating ultrasound and applying the ultrasound to the container which accommodates the water solution with the stable water clusters.

It is also an object of the present invention to provide products with increased concentration of the stable water clusters.

In the present invention the new products with the increased concentration of the stable water clusters are the products which can be produced by the new method of the invention, and in the new apparatus of the invention.

These products with the increased concentration of the stable water clusters can be for example water, a petroleum product, a skin care component, a component providing health benefits, a medication etc, each containing an increased concentration of the stable water clusters.

The new features of the present invention are set forth in particular in the appended claims.

The invention itself, however, as to its construction, method of operation, and composition, will be best understood from the following description of the preferred embodiments, which is accompanied by the following drawings.

### BRIEF DESCRIPTION OF THE DRAWINGS

FIG. 1 is a view showing a perspective view of an apparatus for increasing a concentration of stable water clusters in accordance with one embodiment of the present invention;

FIG. 2 is a view showing another embodiment of the inventive apparatus, which is composed of several individual units;

FIG. 3 is a perspective view of one of the units of the inventive apparatus, in accordance with a further embodiment of the invention;

FIG. 4 is a perspective view of the inventive apparatus, which is composed of two units;

FIG. 5 is a view schematically showing an electrical circuit of the inventive apparatus illustrated in FIG. 4.

### DESCRIPTION OF THE PREFERRED EMBODIMENTS

In accordance with the present invention, a method and an apparatus are proposed for increasing the concentration of stable water clusters. For this purpose, water or water solution is used, which contains the stable water clusters that are made as disclosed for example in our U.S. Pat. Nos. 8, 193,251 and 8,383,688. Thereafter the new inventive method and apparatus is utilized to increase the concentration of the stable water clusters.

In accordance with the present invention, an external electric field is applied to the water solution that contains the stable water clusters. As a result, alignment of the stable water clusters will occur along a direction of the external electric field. The stronger the external electric field, the more aligned are the stable water clusters. When the stable water clusters are aligned, an internal electric field is formed because the dipole moments of the stable water clusters combine. Water molecules adjacent to the stable water clusters align and become attracted firmly to the existing stable water clusters to form a part of new, enlarged stable water clusters. In this way, under the action of the strong external electric field, the stable water clusters grow larger.

The external electric field can be applied to the water solution with the stable water clusters accommodated in a container, for example, by means of two plates between which the container is located, or by means of wires introduced into the container, or by means of wires introduced in the container in combination with the plates located outside of the container.

In order to speed up the process of growth of the stable water clusters, it is desirable to increase the number of the stable water clusters in the water solution. In accordance with the present invention, this can be done by vigorous shaking of the container which contains the water solution with the stable water clusters. This vigorous shaking can be produced by generating ultrasound vibrations of the container. For example, an electrical transducer can be connected with the container and generate ultrasound vibrations of the container and thereby shaking of the water solution with the stable water clusters accommodated in the container.

In accordance with the invention, with the combination of the strong external electrical field and mechanical, for example ultrasound, shaking, a much higher concentration of the stable water clusters with a larger size is achieved.

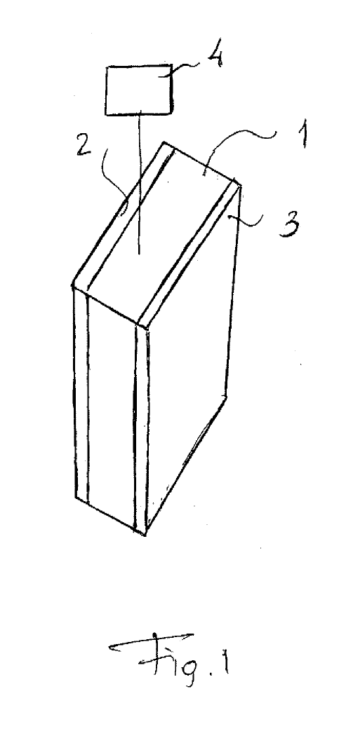

FIG. 1 shows an apparatus for applying external electrical field to the water solution with the stable water clusters in accordance with one embodiment of the invention. The apparatus has a container, formed for example as a rectangular glass tank 1 which accommodates the water solution with the stable water clusters contained in it.

The apparatus further has two plates 2 and 3 which can extend parallel to one another and are spaced from one another to form therebetween a space, in which the tank 1 is located. The tank 1 is filled with water that contains stable water clusters. The plates 2 and 3 are connected with a not shown electric circuit and produce an external electric field applied to the water with the stable water clusters, accommodated in the tank 1. This provides alignment of the stable water clusters and forms an internal electric field because the dipole moments of the stable water clusters combine. Water molecules adjacent to the stable water clusters align and become firmly attracted to the existing stable water clusters. They then become a part of new enlarged stable water clusters, and the stable water clusters grow larger.

The apparatus further has means for vigorous shaking of the tank 1, which can be formed as an electric transducer 4 applied to the tank 1 and generating ultrasound vibrations. While the electrical transducer 4 is shown here as connected to the tank 1, it is also possible to connect the transducer to the tank 1 through a bath of water. The ultrasound applied to the water with the stable water clusters in the tank 1 breaks up the stable water clusters into smaller ones but with large electric dipole moment. These smaller stable water clusters will grow bigger. Since they are maintained under the strong external electric field, these smaller stable water clusters are aligned and the net electric dipole moment is bigger, and also the addition of extra water molecules to these smaller stable water clusters is easier. Thereby the growth of the smaller stable water clusters into the bigger stable water clusters is faster and there are more of them. The combination of the strong external electric field and ultrasonic shaking creates a much higher concentration of the stable water clusters with larger size.

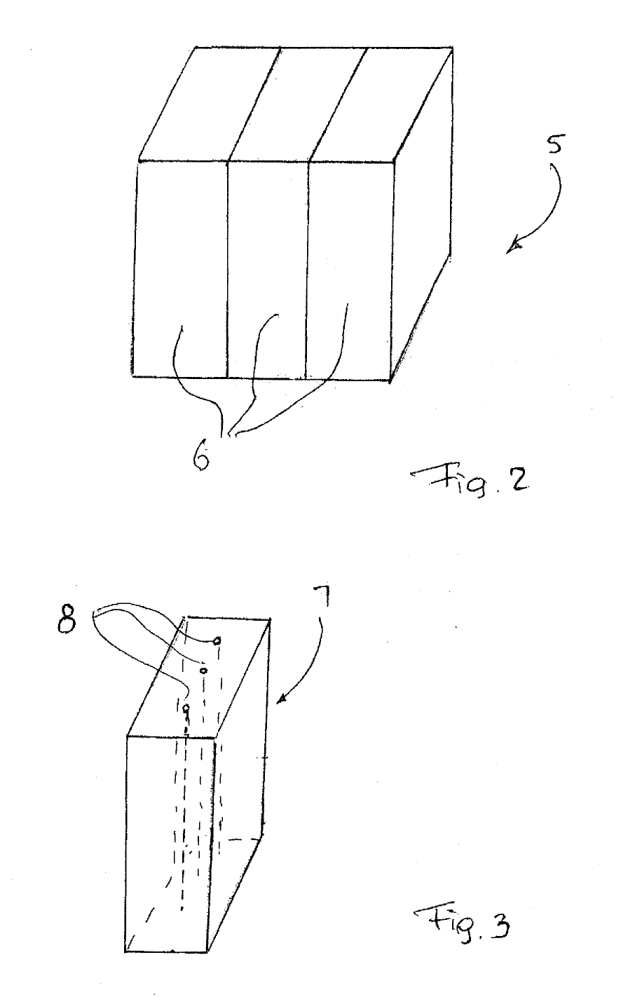

FIG. 2 shows a container 5 of the inventive apparatus for carrying out the inventive method, in accordance with a further embodiment. The container 5 can be composed of a plurality of individual units 6, for example of three units, as shown in this figure.

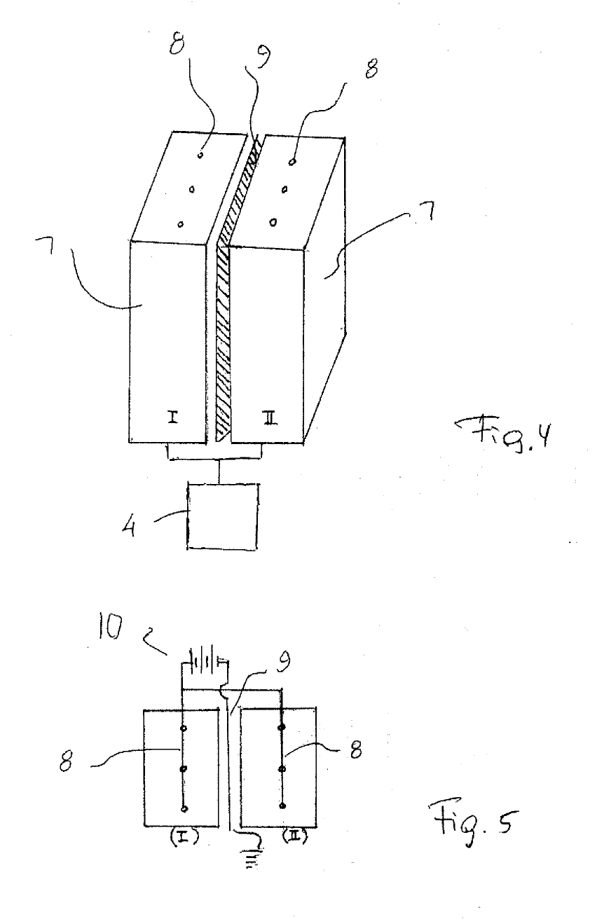

The external electric field can be produced, in accordance with a further embodiment of the invention, in a different way. FIG. 3 shows a unit 7 of the container of the inventive apparatus, which is provided with wire means. The wire means can include a wire or a plurality of wires 8 arranged inside the unit 7. As shown in FIG. 4, the container has two units 7 with the wires 8 inside them, and a grounded conducting plate 9 located between the units 7. The wires 8 and the conducting plate 9 are connected to a power source 10 as shown in FIG. 5. In particular all wires 8 are connected to the same electrode, while the conducting plate 9 is grounded and serves as an opposite electrode. A positive voltage is maintained between the conducting plate 9 and the wires 8. Most of the potential drop occurs near the thin wires 8.

It is also possible to provide in the apparatus a single container with a grounded conducting plate located in its interior and insulated from the water in the container, and with wires or sets of wires also located in the interior of the container, and correspondingly connected to a power source.

During the operation of the inventive apparatus it is recommended to provide a period of the vigorous vibration that is followed by a period of growth without the vigorous vibration.

One example of operation of the apparatus in accordance with the present invention, which carries out the inventive method is presented hereinbelow.

A cylindrical glass container was used to accommodate the water solution that contains the stable water clusters. A conducting element which serves as one electrode and was formed as an aluminum foil was applied on the glass container. A platinum wire was inserted into the glass container in the middle of the water solution, and high voltage of 1,000 volt was applied to the wire. The glass container was placed in an ultrasound bath and was shaken intermittently by turning on the ultrasound bath for 30 minutes.

Table 1 below shows the size and number of the stable water clusters before the shaking and application of 1,000 volt for half an hour. 18 hours later the water solution was measured again. The measurement showed that the total number of the stable water clusters above 0.1 micrometer increases from 331.1 to 984.4333.

TABLE 1
LOCATION: 01 Before SAMPLE SIZE: 3 ml SYRINGE: 25 ml TARE: 0.2 ml
Data is CUMULATIVE and NORMALIZED

| | | | | | | | | | |
|---|---|---|---|---|---|---|---|---|---|
| DATE | TIME | 0.1 | 0.15 | 0.2 | 0.24 | 0.3 | 0.35 | 0.4 | 0.5 |
| 5/16/12 | 14:20:22 | 99266.7 | 44160 | 22660 | 13013.3 | 5053.3 | 2073.3 | 833.3 | 413.3 |
| 5/16/12 | 14:20:25 | 99533.3 | 43566.7 | 22220 | 12153.3 | 4853.3 | 2073.3 | 740 | 326.7 |
| 5/16/12 | 14:20:28 | 98933.3 | 43773.3 | 22986.7 | 13220 | 5413.3 | 2200 | 713.3 | 253.3 |

Run Results

| | | | | | | | | | |
|---|---|---|---|---|---|---|---|---|---|
| 5/16/12 | 14:20:28 | 99244.43 | 43833.33 | 22622.23 | 12795.53 | 5106.633 | 2115.533 | 762.2 | 331.1 |

Run Complete OK
Bottle 1 Overnight Rest After Treatment
LOCATION: 01 SAMPLE SIZE: 3 ml SYRINGE: 25 ml TARE: 02.ml
Data is CUMULATIVE and NORMALIZED

| | | | | | | | | | |
|---|---|---|---|---|---|---|---|---|---|
| DATE | TIME | 0.1 | 0.15 | 0.2 | 0.24 | 0.3 | 0.35 | 0.4 | 0.5 |
| 5/17/12 | 14:11:56 | 142020 | 66326.7 | 31260 | 18546.7 | 9006.7 | 5053.3 | 2306.7 | 986.7 |
| 5/17/12 | 14:11:59 | 142386.7 | 65526.7 | 30380 | 18200 | 8886.7 | 4953.3 | 2140 | 913.13 |
| 5/17/12 | 14:12:02 | 141826.7 | 65880 | 30140 | 17880 | 9060 | 5126.7 | 2380 | 1053.3 |

Run Results

| | | | | | | | | | |
|---|---|---|---|---|---|---|---|---|---|
| 5/17/12 | 14:12:02 | 142077.8 | 85911.13 | 30593.33 | 18208.9 | 89.84.467 | 5044.433 | 2275.567 | 984.4333 |

Run Complete OK

In accordance with the present invention, also products are proposed, which contain increased concentration of the stable water clusters. These new products can be produced by the inventive method and in the inventive apparatus.

The new products with the increased concentration of the stable water clusters can be water, a petroleum product such as for example gasoline, diesel fuel, natural gas, a health benefit providing product such as vitamins, minerals, hormones, extracts, as medication for prevention and treatment of diseases, or another product, each containing the increased concentration of the stable water clusters.

The present invention is not limited to the details shown since various modifications and structural changes are possible without departing from the spirit of the invention.

What is desired to be protected by Letters Patent is set forth in particular in the appended claims:

1. A method of increasing a concentration of stable water clusters in a water solution, comprising the steps of applying to the water solution which contains the stable water clusters an external electric field providing an alignment of electric dipole moments of the stable water clusters and growing of the stable water clusters.

2. A method as defined in claims 1, wherein said applying includes accommodating the water solution which contains the stable water clusters in a container, and acting on the water solution which contains the stable water clusters in the container by acting means which generate the external electric field.

3. A method as defined in claim 2, further comprising forming said acting means as two plates spaced from one another, and arranging the container which contains the water solution with the stable water clusters between the plates.

4. A method as defined in claim 2, further comprising forming said acting means as wire means selected from the group consisting of a single wire and a plurality of wires and located in an interior of the container which accommodates the water solution containing the stable water clusters.

5. A method as defined in claim 1, further comprising shaking the water solution which contains the stable water clusters, so as to break the stable water clusters into a greater number of smaller stable water clusters, which subsequently grow larger so that the concentration of the stable water clusters in the water solution is increased.

6. A method as defined in claim 1, wherein said shaking of the water solution which contains the stable water clusters includes generating ultrasound vibration which provides the shaking.

7. A method as defined in claim 5, wherein said shaking includes accommodating the water solution with the stable water clusters in a container, and shaking the container which accommodates the water solution with the stable water clusters.

8. A method as defined in claim 7, wherein said shaking includes generating ultrasound, and applying the ultrasound to the container which accommodates the water solution with the stable water clusters.

9. An apparatus for increasing a concentration of stable water clusters in a water solution, comprising means applying to the water solution which contains the stable water clusters an external electric field providing an alignment of electric dipole moments of the stable water clusters and growing of the stable water clusters.

10. An apparatus as defined in claims 9, wherein said applying means includes a container accommodating the water solution which contains the stable water clusters in a container, and acting means acting on the water solution which contains the stable water clusters in the container and generating the external electric field.

11. An apparatus as defined in claim 10, wherein said acting means include two plates spaced from one another and arranged outside of the container which contains the water solution with the stable water clusters so that the container is located between the plates.

12. An apparatus as defined in claim 10, wherein said acting means include wire means selected from the group consisting of a single wire and a plurality of wires and located in an interior of the container which accommodates the water solution containing the stable water clusters.

13. An apparatus as defined in claim 9, further comprising means shaking the water solution which contains the stable water clusters, so as to break the stable water clusters into a greater number of smaller stable water clusters, which subsequently grow larger so that the concentration of the stable water clusters in the water solution is increased.

14. An apparatus as defined in claim 13, wherein said means shaking of the water solution which contains the stable water clusters includes means generating ultrasound vibration which provides the shaking.

15. An apparatus as defined in claim 13, further comprising a container accommodating the water solution with the stable water clusters, wherein said shaking means include means shaking the container which accommodates the water solution with the stable water clusters.

16. An apparatus as defined in claim 13, further comprising a container accommodating the water solution with the stable water clusters, wherein said shaking means include means generating ultrasound and applying the ultrasound to the container which accommodates the water solution with the stable water clusters.

17. A product with increased concentration of stable water clusters, produced by the method defined in claim 1.

18. A product as defined in claim 17, wherein the product is selected from the group consisting of a water, a petroleum product, a skin care product, a health benefit providing product, and a medication, each containing the increased concentration of the stable water clusters.
